(19) United States
(12) Patent Application Publication
(10) Pub. No.: US 2013/0050830 A1
(43) Pub. Date: Feb. 28, 2013

(54) Stent Inspection Mandrel

(71) Applicants: Michael Sterud, Prescott, WI (US); Brian Reynolds, Ramsey, MN (US); Roger McGowan, Otsego, MN (US); Mark Steven Smith, Coon Rapids, MN (US); Paul F. Chouinard, Maple Grove, MN (US); Kristopher Henry Vietmeier, Monticello, MN (US)

(72) Inventors: Michael Sterud, Prescott, WI (US); Brian Reynolds, Ramsey, MN (US); Roger McGowan, Otsego, MN (US); Mark Steven Smith, Coon Rapids, MN (US); Paul F. Chouinard, Maple Grove, MN (US); Kristopher Henry Vietmeier, Monticello, MN (US)

(73) Assignee: BOSTON SCIENTIFIC SCIMED, INC., Maple Grove, MN (US)

(21) Appl. No.: 13/240,332

(22) Filed: Sep. 22, 2011

Related U.S. Application Data
(60) Provisional application No. 61/526,547, filed on Aug. 23, 2011.

(51) Int. Cl. G02B 5/02

(52) U.S. Cl. 359/599

(57) ABSTRACT

A covered mandrel that includes a mandrel and a covering. The mandrel has an outer surface and comprises a first material. The covering is engaged to the outer surface of the mandrel and comprises a second material different than the first material. At least a portion of the covered mandrel is configured to scatter light.

### CROSS-REFERENCE TO RELATED APPLICATIONS

This application claims priority from U.S. Application No. 61/526,547, filed on Aug. 23, 2011, the entire content of which is hereby incorporated by reference.

### STATEMENT REGARDING FEDERALLY SPONSORED RESEARCH

Not Applicable

### BACKGROUND OF THE INVENTION

A stent is a medical device introduced to a body lumen and is well known in the art. Stents may be created by methods including cutting or etching a design from a tubular stock, from a flat sheet which is cut or etched and which is subsequently rolled or from one or more interwoven wires or braids. At the end of the production process, a stent is inspected for defects.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

### BRIEF SUMMARY OF THE INVENTION

In at least one embodiment, the invention is directed to a covered mandrel that scatters light. In some embodiments, the mandrel scatters the light. In other embodiments, the covering scatters the light. In at least one embodiment, the covered mandrel is used to inspect a device, such as a stent, for defects.

These and other embodiments which characterize the invention are pointed out with particularity in the claims annexed hereto and forming a part hereof However, for further understanding of the invention, its advantages and objectives obtained by its use, reference can be made to the drawings which form a further part hereof and the accompanying descriptive matter, in which embodiments of the invention are illustrated and described

### BRIEF DESCRIPTION OF THE SEVERAL VIEWS OF THE DRAWING(S)

A detailed description of the invention is hereafter described with specific reference being made to the drawings.

FIG. 1 is a schematic view of a covered mandrel.

FIG. 2 is a schematic illustration of light scattered by the mandrel and transmitted through the covering.

FIG. 3 is a surface profilometer plot.

FIG. 4 is a schematic illustration of light scattered by the rough inner surface of the covering.

FIG. 5 is a schematic illustration of light scattered by the rough inner surface of the covering with the scattered light being transmitted through the mandrel to another portion of the covering.

FIG. 6 is a schematic illustration of light scattered by the rough outer surface of the covering.

FIG. 7 is a schematic illustration of light scattered by light scattering media forming a part of the covering.

FIG. 8 is a schematic illustration of light scattered by a covering with haze.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

As defined in this application “scattering of light” (L_{S}) includes 1) reflection of light, 2) refraction of light, or 3) a combination of reflection or refraction, that occurs 1) within the material, 2) at the interface(s) of the material, or 3) a combination of within the material and the interface(s) of the material.

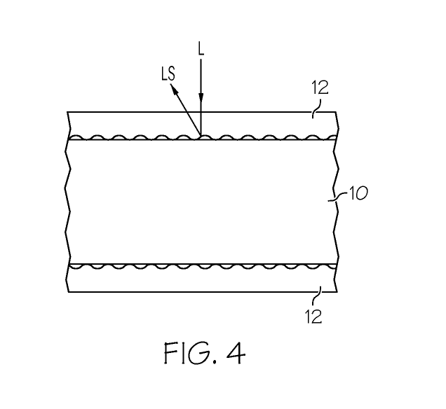

As defined in this application, light (L) is “reflected” when is hits a surface at an angle and is bounced off the surface at an angle. An example of reflection is shown in FIG. 4 where the light (L) is reflected off the rough inner surface of the covering (L_{S}).

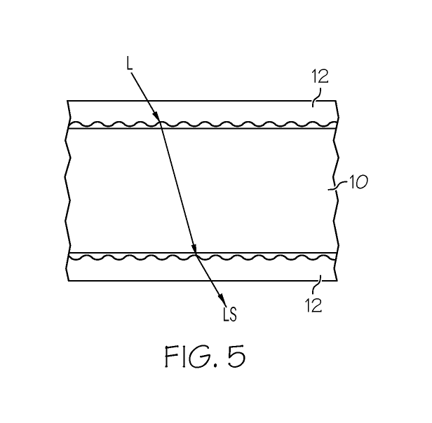

As defined in this application, light is “refracted” when it enters a new medium at an angle and travels at a new angle in the new medium. An example of refraction is shown in FIG. 5 where the light (L) is refracted when it enters the mandrel an when it enters the covering.

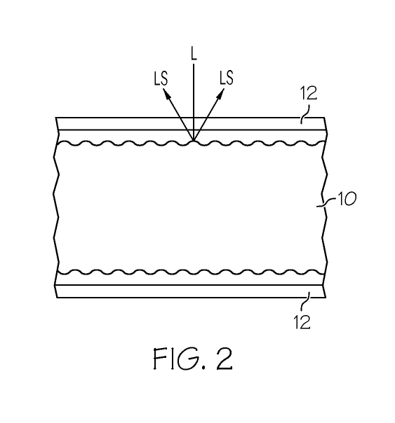

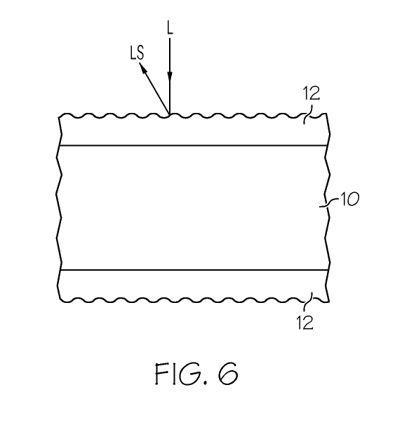

As defined in this application “transmission” of light occurs when light travels through a material. Light transmitted through a portion of the covered mandrel is shown for example in FIGS. 2, 4-5, and 7-8. An example of light that is only reflected and not transmitted by the covered mandrel is shown in FIG. 6 where the light is reflected from the outer surface of the covering.

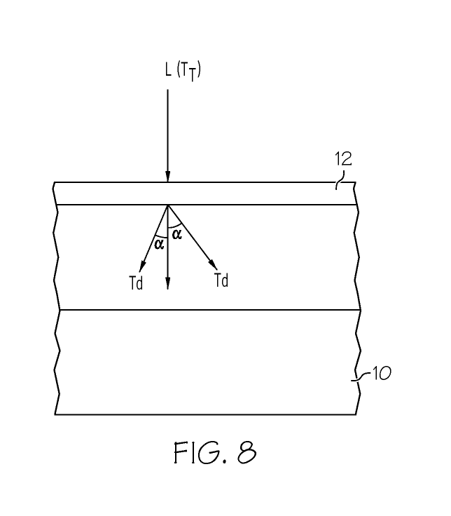

As defined in this application, “haze” is the percentage of total transmitted light that is scattered by more than 2.5 degrees from the direction of the incoming beam of light. FIG. 8 is a schematic illustration of light being transmitted through a covering 12 with haze. In at least one embodiment, haze is described mathematically by the following equation:

$$Haze ( \% ) = \frac{Td}{Tt} \times 100$$

where Td is the scattered transmitted light and Tt is the total transmitted light. In at least one embodiment, light is refracted based on the film's index of refraction value. Haze can be a property of the material or a result of a surface finish of the material. In some embodiments, haze is affected by the crystallinity of the material, additives in the material, processing temperatures used to form the material, and thickness of the material. Haze can be measured by any suitable method. In at least one embodiment, the haze of a material is measured when the material is flat. Thus, for example, in one embodiment, a portion of the coating of a covered mandrel is made into a glass slide sample or equivalent and the haze of the coating is measured.

A. Covered Mandrel

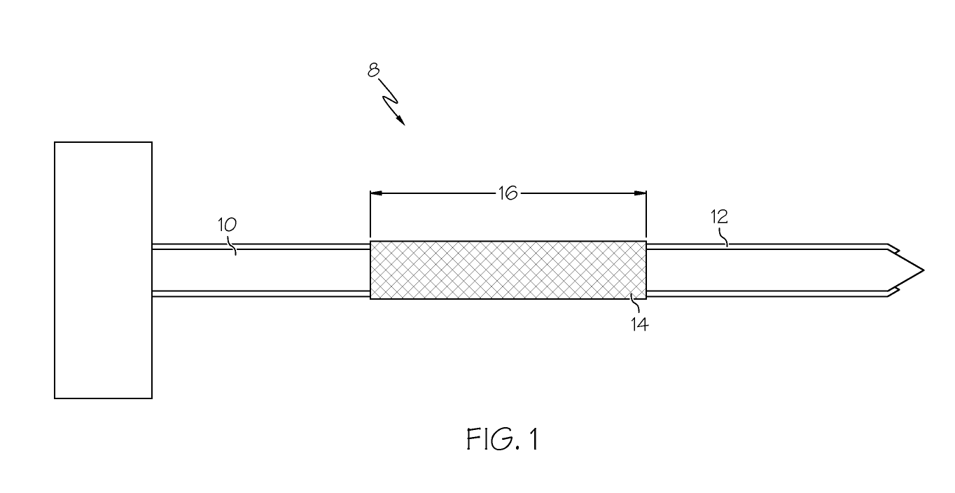

A covered mandrel 8 is shown for example in FIG. 1. In at least one embodiment, the covered mandrel 8 does not abrade, scrape, or otherwise damage an interior surface of a device disposed on the covered mandrel 8. In at least one embodiment, the covered mandrel 8 is used for inspection of a device, such as a stent 14, for defects and/or part dimensions. It is within the scope of the invention for the covered mandrel 8 to be used with any device. In at least one embodiment, the covered mandrel 8 is part of an automated inspection system, not shown. It is within the scope of the invention for the covered mandrel 8 to be used with any suitable inspection system. In some embodiments, the covered mandrel with a device thereon rotates as the light interrogates the covered mandrel from a fixed position.

In at least one embodiment, the covered mandrel 8 includes a mandrel 10 and a covering 12 engaged to the outer surface of the mandrel 10. In some embodiments, the covering 12 is engaged to the entire outer surface of the mandrel 10. In other embodiments, the covering 12 is engaged only to the working portion 16 of the covered mandrel 8. As defined in this application the “working portion” 16 is the entire circumference of a longitudinal section of the covered mandrel 8 that is positioned within a stent, or other device, placed on the covered mandrel.

In at least one embodiment, a smooth surface has a Ra value less than 32 microinches (On) and a rough surface has a Ra value greater than 32 μin. In one embodiment, a smooth surface has a Ra value of 16 μin. A profilometer is used to measure the amount of surface roughness arithmetic average as read in units of instrument stylus motion, the Ra scale.

In at least one embodiment, a hard material has a shore hardness D of 55 to greater than 85 and a soft material has a shore hardness D of 20 to 50.

For each of the embodiments disclosed herein, at least the working portion 16 of the covered mandrel 8 scatters light directed thereto. The scattering of light provides uniform backlight which enables the inspection of a device, for example inspection of the struts of the tubular stent. In at least one embodiment, at least a portion of the covered mandrel uniformly scatters light with a wavelength from about 250 nm (UV) to about 13000 nm (Mid IR). In some embodiments, the mandrel 10 scatters light. In other embodiments, the covering 12 scatters light. In still other embodiments, a combination of the mandrel 10 and the covering 12 scatters light. In one embodiment, transmitted scattered light is used to inspect the device for defects and/or part dimensions.

Some properties of the mandrel 10 in the embodiments described herein include high stiffness and hardness. In some embodiments, the mandrel has a shore hardness D of 55 to greater than 85. In at least one embodiment, the mandrel has haze that is about 5% to about 60%. In some embodiments, the outer surface of the mandrel has haze. In one embodiment, the surface finish of the mandrel provides the mandrel with haze.

Suitable materials to form the mandrel 10 of the covered mandrel embodiments disclosed herein include, but are not limited to, sapphire, ceramic, quartz, borosilicate glass such as Pyrex®, glass, acrylic, a rigid polymer, and any translucent or semi-translucent material of sufficient stiffness.

In some embodiments, the covering 12 is made of a material that is softer than the device to be placed on the covered mandrel 8. In other embodiments, the covering is made of a softer material than the mandrel. In at least one embodiment, the covering has a shore hardness D of 20 to 50.

In at least one embodiment, the covering 12 of the covered mandrel embodiments disclosed herein is comprised of a polymeric material. In at least one embodiment, the covering material(s) does not interfere with the light scattering property of the covered mandrel. For the embodiments described herein, the thickness of the covering 12 is about 0.0001 inches to about 0.005 inches (about 0.00254 mm to about 0.127 mm) In one embodiment, the covering 12 has a thickness of about 0.0002 inches (0.00508 mm) In some embodiments, the thickness of the covering 12 does not interfere with light scattering property of the covered mandrel.

Suitable materials to form the covering 12 of the covered mandrel embodiments disclosed herein include, but are not limited to, nylons, polycarbonate, polymethylmethacrylate, polystyrene, polytetrafluroethylene (PTFE), perfluoroalkoxy copolymer (PFA), polyester, heat shrink materials, and combinations thereof. Suitable nylons include polyether block amides such as Pebax®, and nylon 12s such as Vestamid®. In some embodiments, the covering of the covered mandrel embodiments disclosed herein is a heat shrink material. Examples of suitable heat shrink material include but are not limited to, polyethylenes (e.g. polyolefins), RNF-100 which is a heat shrink tubing available from Raychem Corporation, polyvinylidene fluorides (PVDF) such as Kynar®, nylons, polyvinylchloride (PVC), polytetrafluoroethylene (PTFE), polyether block amides such as Pebax®, polyethylene terephthalate (PET), fluorinated ethylene polymer (FEP), and combinations thereof.

B. Covered Mandrel—Outer Surface of Mandrel Scatters Light

In at least one embodiment, the outer surface of the mandrel 10 scatters light directed onto the covered mandrel 8. FIG. 2 is a non-limiting schematic showing light (L) scattered (L_{S}) by the outer surface of the mandrel 10. In one embodiment, the outer surface of the mandrel 10 is a rough surface that scatters light. It is within the scope of the invention for the surface of the mandrel to be roughened in any suitable manner so that the mandrel surface scatters light.

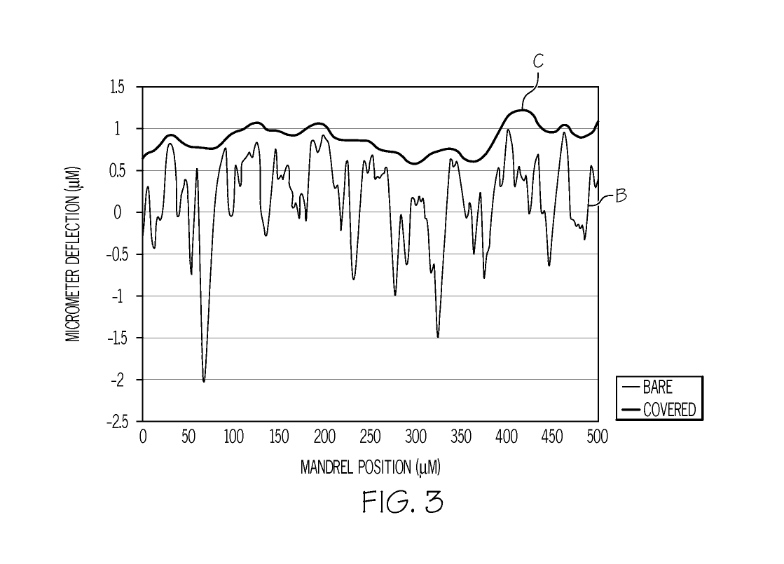

FIG. 3 is a surface profilometer plot of a mandrel surface showing a representative “rough” (bare) surface (B) in combination with the surface profile of the same mandrel which is covered (C). Note the reduction in the number and amplitude of peaks on the covered surface. Without being bound by theory, the covering or coating on a mandrel with a rough outer surface may lessen the surface roughness of the mandrel by 1) reducing the amplitude of the surface profile—particularly by reducing the prominence of peaks on the surface; 2) reducing the number of surface undulations per unit length; or 3) reducing both the amplitude and the number of surface undulations.

In at least one embodiment, the protrusions and intrusions on the surface of the mandrel aid in the scattering of light in that an incident ray of light is reflected and/or refracted by the irregular surface in such a way as to create a uniformly “frosted” appearance beneath the object disposed on the mandrel. When illuminated, this surface provides a uniform light source underneath the object so as to allow for image acquisition and inspection of the object.

In at least one embodiment, the covering 12 is disposed over or on the rough outer surface of the mandrel 10. Thus, the covering 12 forms the outer surface of the covered mandrel. In some embodiments, the outer surface of the covering 12 is smooth. In some embodiments, surface roughness of the covering on the Ra scale is less than 32 μin. In one embodiment, the surface roughness of the cover on the Ra scale is less than 16 μin.

In some embodiments, the covering 12 is a coating on the outer surface of the mandrel 10. In one embodiment, the method of forming the coating provides a coating with a smooth outer surface. For example, methods such as dip coating or spray coating without further modification forms a coating with a smooth outer surface. In other embodiments, the covering 12 is tubular. In one embodiment, the tubular covering is a sleeve. It is within the scope of the invention for the sleeve to be an extruded or cast, polymer tube. In one embodiment, the method of forming an extruded or cast polymer tube has a smooth outer surface.

In at least one embodiment, the covering has a smooth outer surface and an inner surface that does not entirely conform to the rough outer surface of the mandrel. Thereby, a varying thickness air gap is present between the outer covering and the mandrel. In this embodiment, light is scattered by the rough outside surface of the mandrel as well as further scattered by multiple reflections between the mandrel surface and the covering surface.

In at least one embodiment, some of the light directed onto the covered mandrel is scattered by the rough outer surface of the mandrel and some of the light directed onto the covered mandrel is scattered by the rough inner surface of the covering.

In at least one embodiment, the covering 12 is made from a material that does not interfere with the light scattering property of the mandrel 10. In other words, light that is scattered by the mandrel 10 is transmitted through the covering 12. In at least one embodiment, the covering 12 is a transparent material. In some embodiments, the transparent covering has a haze of about 1% to about 5%.

In other embodiments, the covering 12 on the rough outer surface of the mandrel 10 is a coating. In at least one embodiment, the thickness of the coating is sufficient to form a covering 12 with a smooth outer surface. In one embodiment, the coating is a polymeric material. The covering 12 of polymeric coating can be applied to the mandrel 10 by any method including but not limited to dip coating, spray coating, chemical vapor deposition, and any combination thereof. In at least one embodiment the covering formed by spray coating is sintered after being applied to the mandrel 10. Sintering a spray coated polymeric coating cures and hardens the polymeric coating.

In other embodiments, the covering 12 on the rough surface of the mandrel 10 is a tubular sleeve of heat shrink material. In one embodiment, the sleeve of heat shrink material has a smooth outer surface and a smooth inner surface before the application of heat. In at least one embodiment, the thickness of the sleeve of heat shrink material is sufficient to form a covering 12 with a smooth outer surface after the application of heat.

In some embodiments, after the heat shrink material is engaged to the mandrel by the application of heat, the covering has a smooth outer surface and an inner surface that is complementary to the rough outer surface of the mandrel. Thus, the inner surface of the covering is a rough surface.

C. Covered Mandrel—Coating Scatters Light

In at least one embodiment, at least the working portion 16 of the covering 12 of the covered mandrel 8 scatters light directed thereto. This covering 12 can be described as a light scattering covering. In at least one embodiment, the mandrel 10 is made of any suitable material as long as the mandrel and the covering together have a sufficient stiffness or hardness, e.g. a shore hardness D of at least about 55. In some embodiments, the covering is tubular. In one embodiment, the tubular covering is a sleeve. In other embodiments, the covering is a coating on the outer surface of the mandrel.

In some embodiments, the inner surface of a covering 12 is a rough surface and the covering 12 is placed onto a mandrel 10 that has a smooth outer surface. In this embodiment, the roughened inner surface of the covering 12 scatters light. In some embodiments the rough surface of the covering has feature sizes in the range of 1 micron to 90 microns.

In at least one embodiment, the surface of the covering 12 is processed with a roughening technique such as etching, grinding, blasting, plasma treating or etching, to alter the primary processed covering (extruded, cast, sprayed, etc as mentioned above).

In at least one embodiment, the covering 12 has haze that is about 5% to about 60%. In some embodiments, the surface processing of the covering provides the covering with haze. In other embodiments, the material of the covering provides the covering with haze.

As shown in the non-limiting schematic of FIG. 4, there are small spaces between the mandrel 10 and the covering 12 due to the rough inner surface of the covering 12. In other embodiments, the outer surface of the covering is roughened to scatter light. This is shown by the non-limiting schematic of FIG. 6. With either of these embodiments, light directed onto the covered mandrel 12 is scattered by the rough surface of the covering and the scattered light travels away from the covered mandrel thereby providing uniform backlighting.

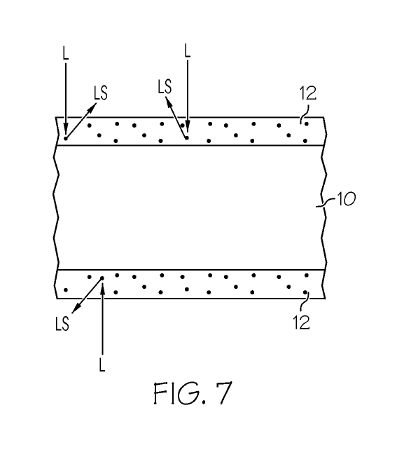

In at least one embodiment, the covering 12 is formed of a material that scatters light. In at least one embodiment, the material forming the covering 12 includes media that scatters light, light scattering media. FIG. 7 is a non-limiting schematic illustration of light scattering media in the covering scattering light. Suitable materials for the light scattering media include titanium dioxide, aluminum oxide, zinc oxide, and any combination thereof. In at least one embodiment, the light scattering media is about 0.01% to about 0.5% by weight of the covering material. In some embodiments, the light scattering media is combined with a polymeric material. In some embodiments, the covering is made of a polymer having a crystalline structure. In this embodiment the crystalline structure of the covering scatters light. Suitable crystalline materials include, but not limited to, polypropylene and nylons such as Grilamid®. Suitable semi-crystalline materials include, but not limited to, polyethylene.

In at least one embodiment, the covering 12 has the property of haze. FIG. 8 is a non-limiting schematic illustration of a covering 12 with haze and light transmitted through the covering 12 being scattered. For illustration purposes only, a space between the covering 12 and the mandrel 10 is shown in FIG. 8 in order to illustrate the scattering of light due to the haze of the covering 12. In at least one embodiment, the covering 12 has haze that is about 5% to about 60%. In one embodiment, a covering with more than 5% haze is not transparent.

In some embodiments, the mandrel 10 is made of a material that reflects the light transmitted through a covering 12 that has haze. In this embodiment, the light that is transmitted through the covering 12 is reflected by the mandrel 10 and probably some minuscule level from the covering. Without being bound by theory, the interrogating light (L) hits the covering with haze, some light may be reflected, then refracted (scattered), and transmitted through to the mandrel; the mandrel in turn reflects/refracts the light; the light is then transmitted through the mandrel to the covering on the other sides of the mandrel; the covering then reflects, refracts, and transmits the light to the air.

D. Method of Inspecting a Stent

One method of inspecting a stent 14 includes providing a covered mandrel 8, placing a stent 14 on the covered mandrel 10, directing light onto the covered mandrel 8 and the stent 14, and inspecting the stent 14. FIG. 1 is a schematic example of a stent 14 disposed on a covered mandrel 8 for stent inspection. In some embodiments, the light is scattered by the mandrel 10 and the scattered light is transmitted through the covering 12. In other embodiments, the light is scattered by the covering 12. In still another embodiment, the light is scattered by the mandrel 10 and by the covering 12. In at least one embodiment, the stent 14 is inspected by obtaining an image of a portion of the stent surface that is being illuminated by the scattered light. In one embodiment the stent 14 is inspected by obtaining an image where the image is of the shadow of the stent. In this embodiment the gaps of the stent are illuminated and imaged. In some embodiments, the covered mandrel assembly is rotating while light is directed to the covered mandrel assembly from a fixed position.

D. Methods of Forming a Covered Mandrel

The following provides non-limiting exemplary methods to form at least one of the covered mandrel embodiments described above.

One method of forming a covered mandrel comprises providing a mandrel and coating the mandrel with a polymer material. The coating method is at least one of dip coating, spray coating, chemical vapor deposition, and combinations thereof. In some embodiments, the method further includes sintering the coating of polymer material where the coating was applied to the mandrel by a spray coating method. In some embodiments, the coating of polymer material has a smooth outer surface and an inner surface that is complementary to the rough outer surface of the mandrel. Thus, the inner surface of the coating is a rough surface. In at least one embodiment, some of the light directed onto the covered mandrel is scattered by the rough outer surface of the mandrel and some of the light directed onto the covered mandrel is scattered by the rough inner surface of the covering.

For the covered mandrel embodiments described above that include a cover in the form of a tubular sleeve, one method of forming a covered mandrel includes pulling a sleeve onto a mandrel so that the sleeve covers the outer surface of the mandrel. The inner diameter of the sleeve is large enough so that the sleeve can be pulled onto the mandrel 10 and small enough so that the sleeve has an interference fit with the mandrel 10. In one embodiment, the inner surface and the outer surface of the sleeve is smooth. In some embodiments there are small spaces between the covering and the mandrel due to the rough outer surface of the mandrel.

One method of forming a covered mandrel comprises placing a sleeve of heat shrink material onto a mandrel, and shrinking the sleeve. In one embodiment, the sleeve is shrunk by applying heat. The heat causes the heat shrink material to shrink thereby engaging the heat shrink material to the outer surface of the mandrel 10. In other embodiments the sleeve is shrunk onto the mandrel through other methods such as stretching the tube or a chemical process.

One method of forming a covered mandrel comprises engaging a covering to the mandrel wherein one surface of the covering is roughened. In one embodiment, the one surface is the inner surface of the covering. In another embodiment, the one surface is the outer surface of the covering. In one embodiment, the covering 12 is tubular and engaged to the mandrel 10 by an interference fit.

One method of forming a covered mandrel comprises applying a light scattering covering to a mandrel. In some embodiments the light scattering covering is a tubular covering engaged to the mandrel by an interference fit. In other embodiments, the light scattering covering is a coating comprising light scattering media. The coating of polymeric material and scattering media can be applied to the mandrel 10 by any method including but not limited to dip coating, spray coating, chemical vapor deposition, and any combination thereof.

The following numbered statements characterize at least one of the embodiments described above.

1. A method of forming a covered mandrel comprising engaging a covering to an outer surface of a mandrel, the covering being made of a first material, the mandrel being made of a second material different than the first material, wherein at least a portion of the mandrel is configured to scatter light.

2. The method of statement 1, the outer surface of the mandrel being a rough surface configured to scatter light.

3. The method of statement 1, wherein the covering is configured to scatter light, the first material comprising light scattering media.

4. The method of statement 1, wherein the covering is configured to scatter light, the first material having either a crystalline or semi-crystalline structure.

5. The method of statement 1, wherein engaging is at least one method selected from the group consisting of dipping and spray coating the first material onto the outer surface of the mandrel.

6. The method of statement 1, the covering being a sleeve, wherein engaging the covering is by an interference fit.

7. The method of statement 1, the first material being a heat shrink material, wherein engaging the covering is by applying heat to the heat shrink material.

The following numbered statements characterize at least one of the embodiments described above.

1. A covered mandrel, the covered mandrel comprising a mandrel and a covering, the mandrel having an outer surface, the mandrel comprising a first material, the covering being engaged to the outer surface of the mandrel, the covering comprising a second material different than the first material, wherein the outer surface of the mandrel is a rough surface that scatters light.

2. The covered mandrel of statement 1, wherein the first material is selected from the group consisting of sapphire, ceramic, quartz, glass, borosilicate glass, acrylic, and any combination thereof.

3. The covered mandrel of statements 1-2, wherein the second material is a heat shrink material.

4. The covered mandrel of statement 3, the heat shrink material being selected from the group consisting of polyethylenes, polyolefins, polyvinylidene fluorides (PVDF), nylons, polyvinylchloride (PVC), polytetrafluoroethylene (PTFE), polyether block amides, polyethylene terephthalate (PET), polyester and fluorinated ethylene polymers (FEP).

5. The covered mandrel of statements 1-2, wherein the second material is selected from the group consisting of nylons, polycarbonates (PC), poly(methyl methacrylate) (PMMA), polystyrene, polytetrafluoroethylene (PTFE), perflouroalkoxy copolymer (PFA), and any combination thereof.

6. The covered mandrel of statements 1-5, the covering being a transparent material.

7. The covered mandrel of statements 1-6, the covering having a haze of about 1% to about 5%.

8. The covered mandrel of statements 1-7, the covering having a surface roughness that is less than 32 μin Ra.

9. The covered mandrel of statements 1-8, the covering having a surface roughness that is less than 16 μin Ra.

10. The covered mandrel of statements 1-9, the covering having a smooth outer surface.

11. The covered mandrel of statement 10, the covering further having a smooth inner surface.

12. The covered mandrel of statements 1-11, wherein the covering is a tube.

13. The covered mandrel of statements 1-12, where an air gap is between an inner surface of the covering and the rough outer surface of the mandrel, the air gap having a varying thickness, wherein light is further scattered by multiple reflections between the rough outer surface of the mandrel and the inner surface of the covering.

14. The covered mandrel of statements 1-11, wherein the covering is a coating of second material.

15. A covered mandrel, the covered mandrel comprising a mandrel and a covering, the mandrel having an outer surface, the mandrel comprising a first material, the covering being engaged to the outer surface of the mandrel, the covering comprising a second material different than the first material, wherein light is scattered within the second material.

16. The covered mandrel of statement 15, the second material comprising light scattering media.

17. The covered mandrel of statement 15, wherein the light scattering media is selected from the group consisting of titanium dioxide, aluminum oxide, zinc oxide, and any combination thereof.

18. The covered mandrel of statement 17, wherein the light scattering media is about 0.01% to about 0.5% by weight of the covering.

19. The covered mandrel of statement 15, wherein the second material has either a crystalline or semicrystalline structure.

20. The covered mandrel of statement 15-19, wherein the composition of the second material has haze, wherein the haze is more than 5% to about 60%.

21. The covered mandrel of statements 15-20, wherein at least some of the light scattered by the covering is reflected by the mandrel.

22. The covered mandrel of statements 15-21, the tubular covering having a smooth outer surface.

23. The covered mandrel of statement 22, the tubular covering further having a smooth inner surface.

24. The covered mandrel of statements 15-23, wherein the covering is tubular.

25. The covered mandrel of statements 15-24, where an air gap is between an inner surface of the covering and an outer surface of the mandrel, the air gap having a varying thickness, wherein light is further scattered by multiple reflections between the outer surface of the mandrel and the inner surface of the covering.

26. The covered mandrel of statements 15-22, wherein the covering is a coating of second material.

27. A covered mandrel, the covered mandrel comprising a mandrel and a covering, the mandrel having an outer surface, the mandrel comprising a first material, the covering being engaged to the outer surface of the mandrel, the covering comprising a second material different than the first material, the covering having an outer surface and an inner surface wherein the inner surface is a rough surface that scatters light.

28. The covered mandrel of statement 27, wherein the second material is selected from the group consisting of nylons, polycarbonates (PC), poly(methyl methacrylate) (PMMA), polystyrene, polytetrafluoroethylene (PTFE), perflouroalkoxy copolymer (PFA), polyethylenes, polyolefins, polyvinylidene fluorides (PVDF), polyvinylchloride (PVC), polytetrafluoroethylene (PTFE), polyether block amides, polyethylene terephthalate (PET), polyester, fluorinated ethylene polymer (FEP), and any combination thereof.

29. The covered mandrel of statements 27-28, the rough surface of the covering having surface features with a size greater than 1 micron.

30. The covered mandrel of statements 27-29, the covering being tubular.

31. The covered mandrel of statements 27-30, where an air gap is between an inner surface of the covering and an outer surface of the mandrel, the air gap having a varying thickness, wherein light is further scattered by multiple reflections between the outer surface of the mandrel and the inner surface of the covering.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the invention. Those skilled in the art may recognize other equivalents to the specific embodiment described herein which equivalents are intended to be encompassed by the claims attached hereto.

1. A covered mandrel, the covered mandrel comprising a mandrel and a covering, the mandrel having an outer surface, the mandrel comprising a first material, the covering being engaged to the outer surface of the mandrel, the covering comprising a second material different than the first material, wherein the outer surface of the mandrel is a rough surface that scatters light.

2. The covered mandrel of claim 1, wherein the first material is selected from the group consisting of sapphire, ceramic, quartz, glass, borosilicate glass, acrylic, and any combination thereof.

3. The covered mandrel of claim 1, wherein the second material is a heat shrink material.

4. The covered mandrel of claim 3, the heat shrink material being selected from the group consisting of polyethylenes, polyolefins, polyvinylidene fluorides (PVDF), nylons, polyvinylchloride (PVC), polytetrafluoroethylene (PTFE), polyether block amides, polyethylene terephthalate (PET), polyester, and fluorinated ethylene polymers (FEP).

5. The covered mandrel of claim 1, wherein the second material is selected from the group consisting of nylons, polycarbonates (PC), poly(methyl methacrylate) (PMMA), polystyrene, polytetrafluoroethylene (PTFE), perflouroalkoxy copolymer (PFA), and any combination thereof.

6. The covered mandrel of claim 1, wherein the covering is a tube, the covering having a smooth outer surface and a smooth inner surface.

7. A covered mandrel, the covered mandrel comprising a mandrel and a covering, the mandrel having an outer surface, the mandrel comprising a first material, the covering being engaged to the outer surface of the mandrel, the covering comprising a second material different than the first material, wherein light is scattered within the second material.

8. The covered mandrel of claim 7, the second material comprising light scattering media.

9. The covered mandrel of claim 7, wherein the light scattering media is selected from the group consisting of titanium dioxide, aluminum oxide, zinc oxide, and any combination thereof.

10. The covered mandrel of claim 9, wherein the light scattering media is about 0.01% to about 0.5% by weight of the covering.

11. The covered mandrel of claim 7, wherein the second material has either a crystalline or semicrystalline structure.

12. The covered mandrel of claim 7, wherein the composition of the second material has haze, wherein the haze is more than 5% to about 60%.

13. A covered mandrel, the covered mandrel comprising a mandrel and a covering, the mandrel having an outer surface, the mandrel comprising a first material, the covering being engaged to the outer surface of the mandrel, the covering comprising a second material different than the first material, the covering having an outer surface and an inner surface wherein the inner surface is a rough surface that scatters light.

14. The covered mandrel of claim 13, wherein the second material is selected from the group consisting of nylons, polycarbonates (PC), poly(methyl methacrylate) (PMMA), polystyrene, polytetrafluoroethylene (PTFE), perflouroalkoxy copolymer (PFA), polyethylenes, polyolefins, polyvinylidene fluorides (PVDF), polyvinylchloride (PVC), polytetrafluoroethylene (PTFE), polyether block amides, polyethylene terephthalate (PET), polyester, fluorinated ethylene polymer (FEP), and any combination thereof.
